(19) United States
(12) Patent Application Publication
(10) Pub. No.: US 2006/0064920 A1
(43) Pub. Date: Mar. 30, 2006

(54) Combined outrigger holder and fishing rod holder

(76) Inventors: Roger Wilcox, Ft. Lauderdale, FL (US); Scott A. Wilcox, Plantation, FL (US)

Correspondence Address: BENASUTTI, P.A., 17294 BERMUDA VILLAGE DRIVE, BOCA RATON, FL, 33487, US

(21) Appl. No.: 11/237,605

(22) Filed: Sep. 27, 2005

Related U.S. Application Data
(63) Continuation-in-part of application No. 60/614,633, filed on Sep. 29, 2004.

(51) Int. Cl. A01K 97/10

(52) U.S. Cl. 43/21.2

(57) ABSTRACT

An apparatus is described, combining and outrigger holder with a fishing rod holder, so that both can be moved to a plurality of positions in both a horizontal plane and a vertical plane.

### CROSS REFERENCE TO RELATED APPLICATIONS

This application claims the benefit of the filing date of our prior co-pending application No. 60/614,633 filed Sep. 29, 2004, entitled “Combined outrigger holder and rod holder”, and the applications referenced therein, No. 10/801,275, filed Mar. 16, 2004, entitled “T-TOP OUTRIGGER HOLDER APPARATUS” and application No. 60/455,982, filed Mar. 19, 2003, the disclosures of which are incorporated herein by reference as if fully set forth.

### BACKGROUND OF THE INVENTION

1. Technical Field

This invention relates to fishing equipment and, more particularly, to fishing rod and outrigger holders for use on boats to hold either the outrigger or the rod or both.

2. Description of the Prior Art

In the prior art of sport fishing equipment, it is known to use outriggers to play out trolling lines away from the sides and back of the boat. These outriggers can be moved in line with the hull and in-board of the boat when they are not being used for trolling. Thus, they are adjustable between the trolling position and the storage position.

These outriggers can be mounted on bases which are either fixed to the gunnels or tops of the boats or are fixed and adjustable, in that the outrigger can be swung out outwardly to a second fixed position. Prior art outriggers are shown in U.S. Pat. Nos. 2,927,754, 3,008,259, 3,161,390, 3,195,094, 3,724,791, 5,445,102, and 5,592,893. These patents also show the holders for the outriggers. Many of these patents disclose two means of adjustment: one means of rotating the outrigger and another means of angling the outrigger in a vertical position.

Fishing boats are normally fitted with outrigger and fishing rod holders mounted in the gunnels; as, for example, is shown in the prior art U.S. Pat. No. 5,163,244 (see Prior Art FIG. 1, attached to this application).

A problem with such holders is that they can only be used for one device at a time. Furthermore, they are not adjustable for positioning the outriggers in various inboard, parallel, outboard, and elevated positions.

### BRIEF DESCRIPTION OF DRAWINGS

FIG. 1 is a view taken from a prior art patent;

FIG. 2 is a section taken as indicated by the lines and arrows A-A of a portion of a typical apparatus as shown in FIG. 1;

FIG. 3 is an exploded perspective view, partially broken away of a portion of an apparatus in accordance with our invention;

FIG. 4 is an exploded perspective view, partially broken away of a portion of an apparatus in accordance with our invention;

FIG. 5 is an exploded perspective view of a portion of an apparatus in accordance with our invention;

FIG. 6 is a side view of a portion of the apparatus shown in FIG. 5; and

FIG. 7 is a vertical, central section of the side view shown in FIG. 6.

### DESCRIPTION OF THE PREFERRED EMBODIMENTS

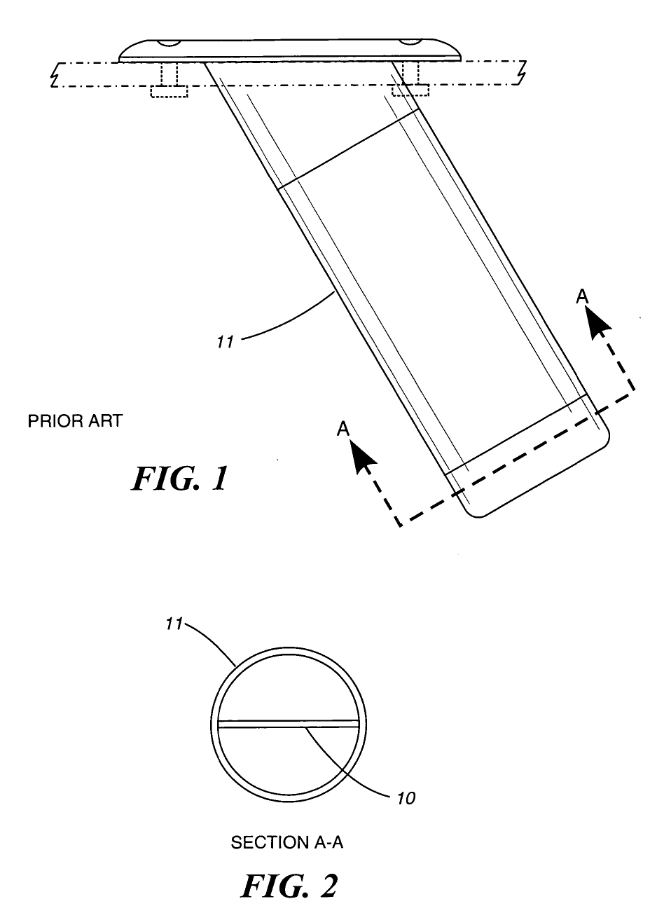

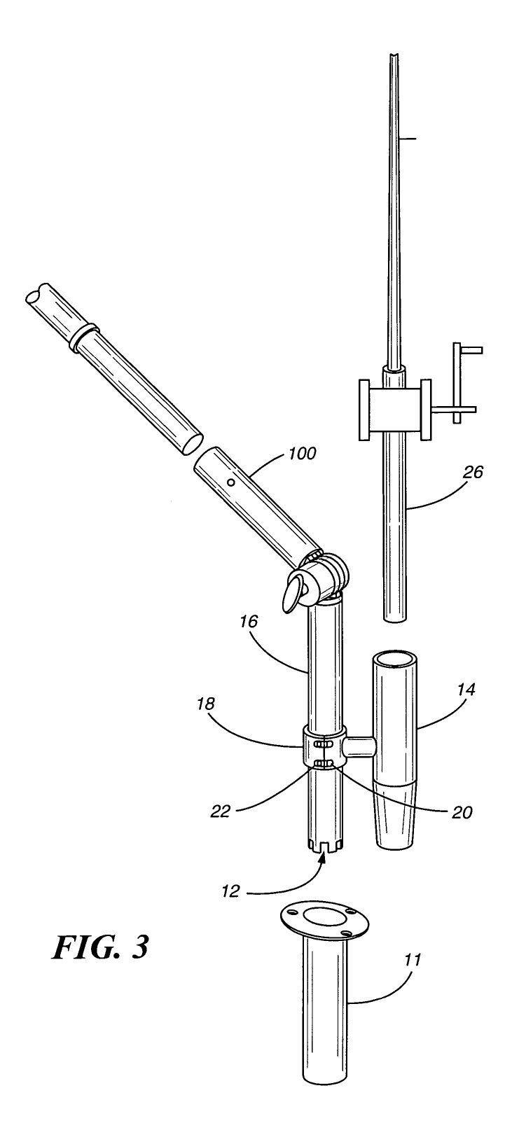

Referring to the Figures, FIG. 1 shows a prior art fishing rod holder 11 for permanent installation in a gunnel of a fishing boat. Taking a section as indicated by the lines and arrows A-A in FIG. 1, the usual holder structure would have a pin 10 across the inside near the bottom. The purpose of the pin 10 is to accommodate the notches in the bottom of a fishing rod. We provide similar notches, designated generally 12 FIG. 3 in the bottom of an outrigger holder 16. Thus the rod or the outrigger holder can be moved, i.e. rotated, to a number of fixed positions; wherein the notches embrace the pin; and the structure will not rotate.

In accordance with our invention, a clamp-on rod holder 14 is provided; which can be clamped on to the outrigger holder 16 by any suitable clamp means 18. The clamp means 18 is most preferably releaseable as by means of screws 20 fitted into bosses 22. Thus the fishing rod holder 11 can now accommodate our outrigger holder 16 and simultaneously provide a fishing rod holder 14 for the rod 26. It will be understood that the rod holder 14 has a cross-wise internally mounted pin near the bottom to accommodate the notches in the bottom of a fishing rod, as aforesaid.

The clamp-on fishing rod holder 14 may also be used to clamp the holder onto other structural parts of the boat, such as, the tubular structure of a “T” top boat. Thus it provides a means to position rods at other than a fixed number of places on the boat.

The outrigger holder 16 is preferably of a type which provides for adjustment to various angles, i.e. for positioning the outriggers in various inboard, parallel, outboard, and elevated positions. See our prior application 10/801275 referenced hereinabove. The arm 100 of the outrigger holder can be adjusted to a plurality of positions in a vertical plane and the holder 16 can be raised from the mount 11 and rotated in a horizontal plane and then lowered into engagement with the pin 10 to fix it in a different horizontal position. Also the rod holder can be mounted on the arm 100 to provide adjustment in a vertical plane.

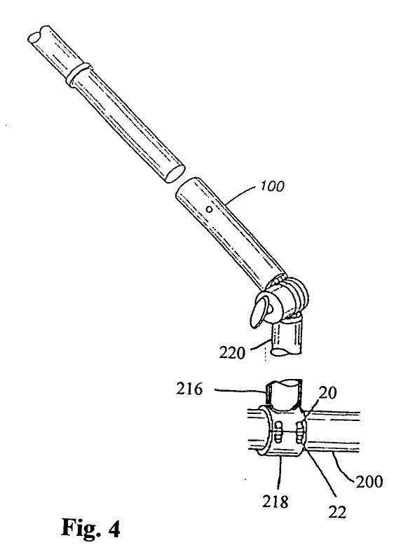

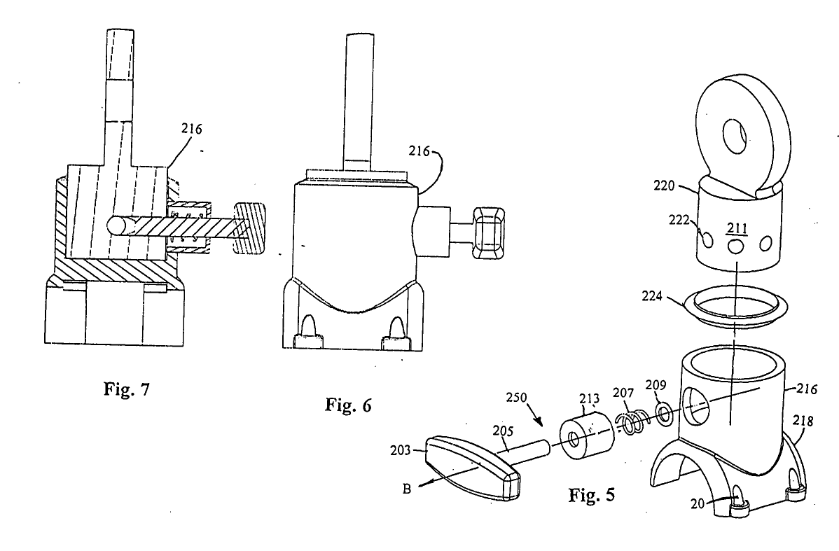

In an alternate embodiment shown in FIGS. 4 and 5, we provide a means of mounting the outrigger holder 216 to the tubular structure 200 FIG. 4 of a boat; such as is found on a “T” top construction. Herein the clamp 218 is fixed to or an integral part of a lower portion 216 of the outrigger holder. An upper portion 220 of the outrigger holder is mounted for rotation within the lower portion 216. The upper portion 220 has a plurality of radially extending holes 22 therein spaced circumferentially as shown in FIG. 5. A seal 224 is positioned between the portions 220 and 216 to prevent debris from lodging therebetween.

A spring loaded handle and plunger means designated generally 250, is provided mounted in the lower portion 216 to engage the holes 222 in the upper portion upon rotation thereof and prevent further rotation thereof. To rotate the upper portion 220 with respect to the lower portion 216, the handle 203 is retracted in the direction of the arrow “B”, thereby retracting the pin 205 from one of the holes 222 and allowing the upper portion 216 to be turned in a horizontal plane. Upon release of the handle 203, the spring 207 expands against the spring retainer 209 (which is fixedly attached to the pin 205) and forces the pin against the surface 211 of the upper portion 216. As the upper portion 216 continues to be rotate, the pin 205 eventually engages a hole 222 and prevents further rotation. The housing 213 mounted to the lower portion 216, retains and guides the pin 205. FIG. 6 is a side view of a portion of the assembled portion of the apparatus shown in FIG. 5; and FIG. 7 is a central vertical section of that apparatus.

From what we have described, we have invented a combined outrigger holder and fishing rod holder wherein means are provided for adjusting the outrigger holder to a plurality of positions in both a horizontal plane and a vertical plane and wherein means are provided for adjusting the fishing rod holder to a plurality of positions in both a horizontal plane and a vertical plane.

1. A combined outrigger holder and fishing rod holder apparatus having means for adjustment of the outrigger holder to a plurality of positions in both a horizontal plane and a vertical plane.

2. The combined outrigger holder and fishing rod holder of claim 1 wherein means are provided for adjusting the fishing rod holder to a plurality of positions in both a horizontal plane and a vertical plane.
